(19) United States
(12) Patent Application Publication
(10) Pub. No.: US 2008/0163238 A1
(43) Pub. Date: Jul. 3, 2008

(54) Dynamic load balancing architecture

(76) Inventor: Fan Jiang, Foster City, CA (US)

Correspondence Address: STATTLER - SUH PC, 60 SOUTH MARKET STREET, SUITE 480, SAN JOSE, CA, 95113, US

(21) Appl. No.: 11/648,028

(22) Filed: Dec. 28, 2006

(51) Int. Cl. G06F 9/46

(52) U.S. Cl. 718/105

(57) ABSTRACT

A system and method to perform dynamic balancing of task loads are described. A plurality of task files stored within a storage device are organized in descending order based on a respective processing time parameter associated with each task file, which characterizes the length of time necessary for processing of each respective task file. Processing of the task files is further initiated. Finally, each available task file is retrieved and processed successively from the plurality of ordered task files.

### TECHNICAL FIELD

The present invention relates generally to computer applications and, more particularly, to a system and method to perform dynamic balancing of task loads within a computer system.

### BACKGROUND OF THE INVENTION

The explosive growth of the Internet as a publication and interactive communication platform has created an electronic environment that is changing the way business is transacted. As the Internet becomes increasingly accessible and popular around the world, larger amounts of data need to be efficiently catalogued and stored within respective entities with presence on the network.

Some proposed inventory management systems use a large number of machines to process the increasing volume of data tasks, which are assigned to respective machines in a predefined manner prior to the actual processing. However, such predefined task assignment may lead to uneven load distribution, and, as a result, inefficient task processing.

Thus, what is needed is a system and method to balance the task load dynamically in order to achieve scalability and efficient task processing time.

### SUMMARY OF THE INVENTION

A system and method to perform dynamic balancing of task loads are described. A plurality of task files stored within a storage device are organized in descending order based on a respective processing time parameter associated with each task file, which characterizes the length of time necessary for processing of each respective task file. Processing of the task files is further initiated. Finally, each available task file is retrieved and processed successively from the plurality of ordered task files.

### BRIEF DESCRIPTION OF THE DRAWINGS

The present invention is illustrated by way of example and not intended to be limited by the figures of the accompanying drawings in which like references indicate similar elements and in which:

FIG. 1 is a flow diagram illustrating a processing sequence to perform dynamic balancing of task loads, according to one embodiment of the invention;

FIG. 2 is a block diagram illustrating a system to perform dynamic balancing of task loads, according to one embodiment of the invention;

FIG. 3 is a flow diagram illustrating a method to order task files within a storage device, according to one embodiment of the invention;

FIG. 4 is a flow diagram illustrating a method to initiate processing of task files, according to one embodiment of the invention;

FIG. 5 is a flow diagram illustrating a method to process task files, according to one embodiment of the invention;

FIG. 6 is a diagrammatic representation of a machine in the exemplary form of a computer system within which a set of instructions may be executed.

### DETAILED DESCRIPTION

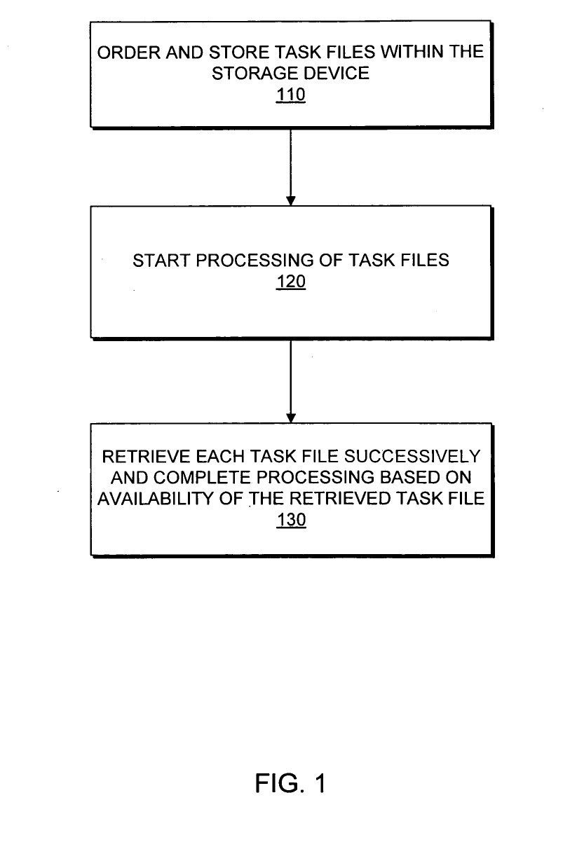

FIG. 1 is a flow diagram illustrating a processing sequence to perform dynamic balancing of task loads, according to one embodiment of the invention. As shown in FIG. 1, at processing block 110, the sequence starts with ordering of task files within a storage device and further storage of the ordered task files within the device. In one embodiment, a master processing machine, such as, for example a processing server within a network-based entity, accesses a storage device to order multiple task files stored within the storage device based on a processing time parameter associated with each task file, which characterizes the length of time necessary to complete the processing of the respective task file, as described in further detail below.

Next, at processing block 120, task file processing is started. In one embodiment, the master processing machine initiates processing of task files. At the same time, the master processing machine further transmits a command to initiate processing of task files to multiple slave processing machines coupled to the master processing machine and to the storage device, as described in further detail below.

Finally, the sequence continues at processing block 130, where each ordered task file is successively retrieved and processed. In one embodiment, the master processing machine and the associated slave processing machines retrieve the task files in descending order based on their respective processing time parameters and process the task files successively, as described in further detail below.

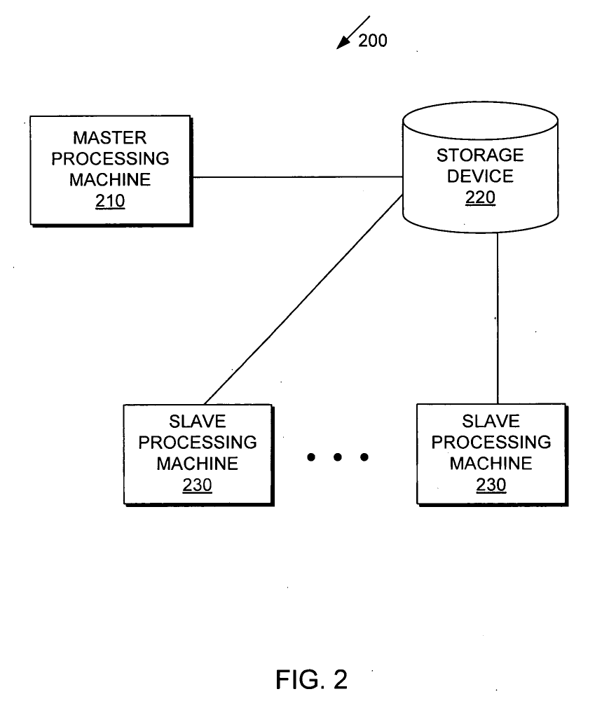

FIG. 2 is a block diagram illustrating a system to perform dynamic balancing of task loads. While an exemplary embodiment of the present invention is described within the context of a system 200 enabling such dynamic load balancing operations, such as, for example, a UNIX-based computer system, it will be appreciated by those skilled in the art that the invention will find application in many different types of computer-based, and network-based, systems, such as, for example, processing servers within network-based entities, content provider entities, or other known entities.

In one embodiment, the system 200 includes a central storage device 220 and multiple processing machines coupled to the storage device 220, such as, for example, a master processing machine 210 and one or more slave processing machines 230 coupled to the master processing machine 210.

In one embodiment, the master processing machine 210 is a hardware and/or software entity configured to perform ordering operations and task processing operations, as described in further detail below. The slave processing machines 230 are hardware and/or software entities configured to perform task processing operations, as described in further detail below.

In one embodiment, the storage device 220, which at least partially implements and supports the system 200, may include one or more storage facilities, such as a database or collection of databases, which may be implemented as relational databases. Alternatively, the storage device 220 may be implemented as a collection of objects in an object-oriented database, as a distributed database, or any other such databases.

The storage device 220 stores, inter alia, multiple task files, each task file having a predetermined size measured by a corresponding processing time parameter, which defines the length of time required for processing of each respective task file. The master processing machine 210 and the slave processing machines 230 access the storage device 220 in a predetermined sequence to retrieve and process the stored task files, as described in further detail below.

In one embodiment, the master processing machine 210, the slave processing machines 230, and the storage device 220 may be coupled through a network (not shown). Examples of networks that processing machines may utilize to access the storage device 220 may include a wide area network (WAN), a local area network (LAN), a wireless network (e.g., a cellular network), the Plain Old Telephone Service (POTS) network, or other known networks. Alternatively, the master processing machine 210, the slave processing machines 230, and the storage device 220 may operate within the system 200 without being coupled to a network.

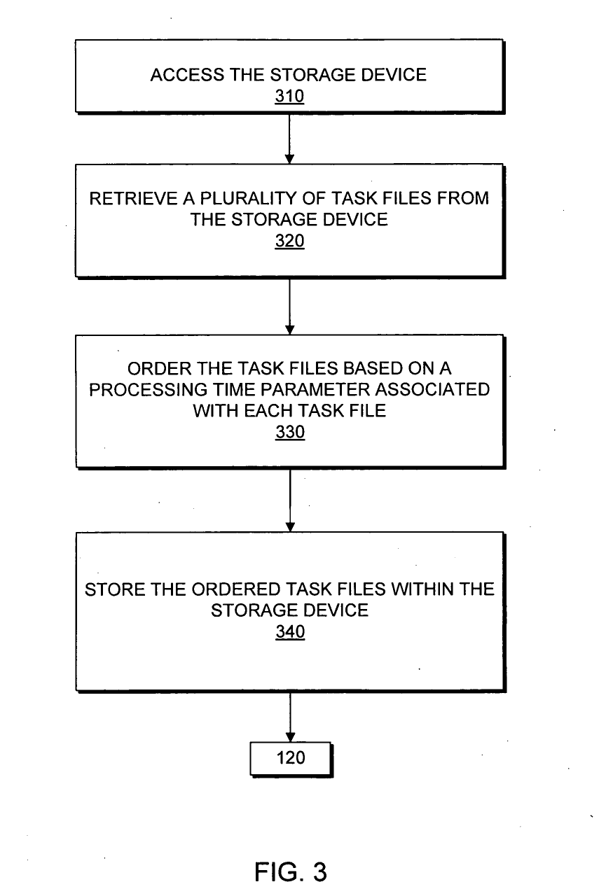

FIG. 3 is a flow diagram illustrating a method to order task files within a storage device, shown above at processing block 110. As illustrated in FIG. 3, at processing block 310, the storage device 220 is accessed. In one embodiment, the master processing machine 210 accesses the storage device 220 through a network file system connection within the system 200.

At processing block 320, a plurality of task files are retrieved from the storage device 220. In one embodiment, the master processing machine 210 retrieves multiple task files stored within the storage device 220.

At processing block 330, the retrieved task files are ordered based on a processing time parameter associated with each task file. In one embodiment, each task file is characterized by a processing time parameter, which defines the length of time required to process the respective task file. The master processing machine 210 orders the retrieved task files in descending order based on the value of their respective processing time parameter.

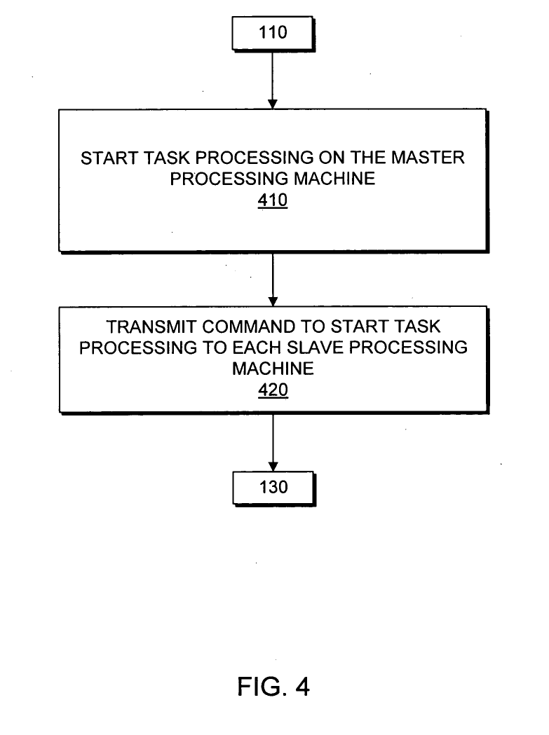

At processing block 340, the ordered task files are stored within the storage device 220. In one embodiment, the master processing machine 210 stores the ordered list of task files within the storage device 220. The procedure then jumps to processing block 120, described in detail in connection with FIG. 4.

FIG. 4 is a flow diagram illustrating a method to initiate processing of task files. As shown in FIG. 4, at processing block 410, the task processing operation is started on the master processing machine 210. In one embodiment, the master processing machine 210 initiates processing of the task files stored within the storage device 220.

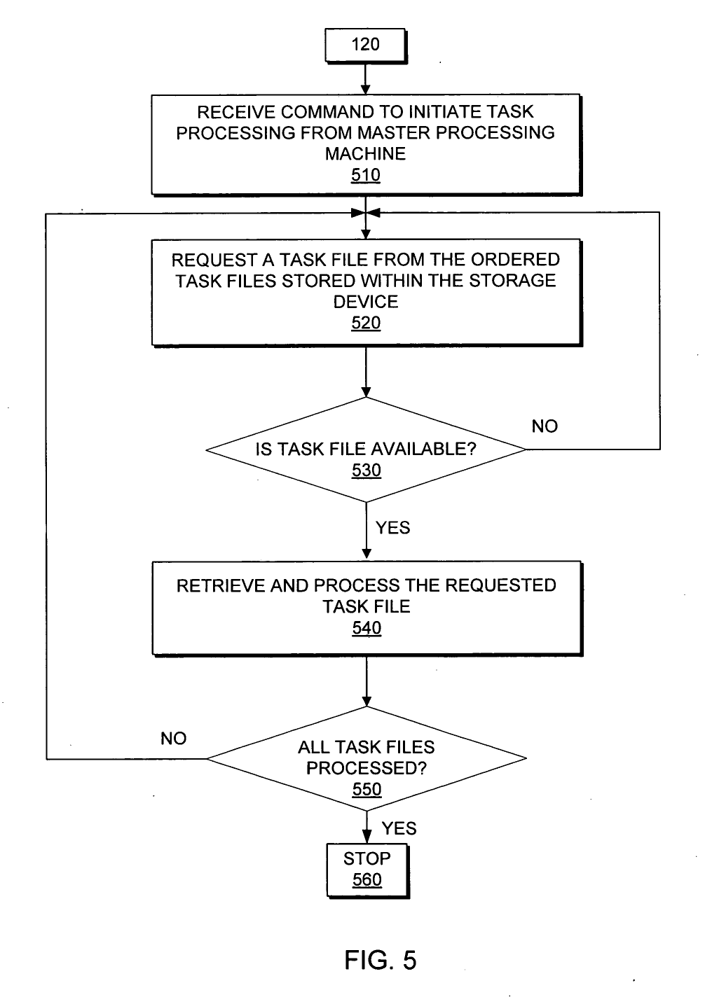

At processing block 420, a command to start task processing is transmitted to each slave processing machine 230. In one embodiment, the master processing machine 210 transmits a command to initiate processing of the task files to each slave processing machine 230. The procedure then jumps to processing block 130, described in detail in connection with FIG. 5.

FIG. 5 is a flow diagram illustrating a method to process task files. As shown in FIG. 5, at processing block 510, a command to initiate processing of task files is received from the master processing machine 210. In one embodiment, each slave processing machine 230 receives the command to initiate task processing from the master processing machine 210.

At processing block 520, a task file is requested from the ordered task files stored within the storage device 220. In one embodiment, each processing machine, such as the master processing machine 210 and the slave processing machines 230, accesses the storage device 220 successively, or according to a predetermined sequence, to request a task file for further processing, starting with the task files having a larger size and, thus, a longer processing time. In one embodiment, if several machines request the same task file, only one machine 210, 230 will have access to the task file, and, as a result, each task file will be processed only once during the entire processing sequence.

At processing block 530, a decision is made whether the requested task file is available. If the requested task file has already been claimed by a processing machine and is not available, the procedure jumps to processing block 520 and the next task file in the ordered list of task files is claimed.

Otherwise, if the task file is available, at processing block 540, the requested task file is retrieved and processed. In one embodiment, the processing machine requesting the available task file retrieves and processes the task file until completion.

At processing block 550, a decision is made whether all task files are processed. If all task files are processed, then the procedure stops at processing block 560.

Otherwise, if there are still task files to be processed, the procedure jumps to processing block 520, where each respective machine requests a new task file from the remaining ordered task files, and processing blocks 520 through 550 are repeated.

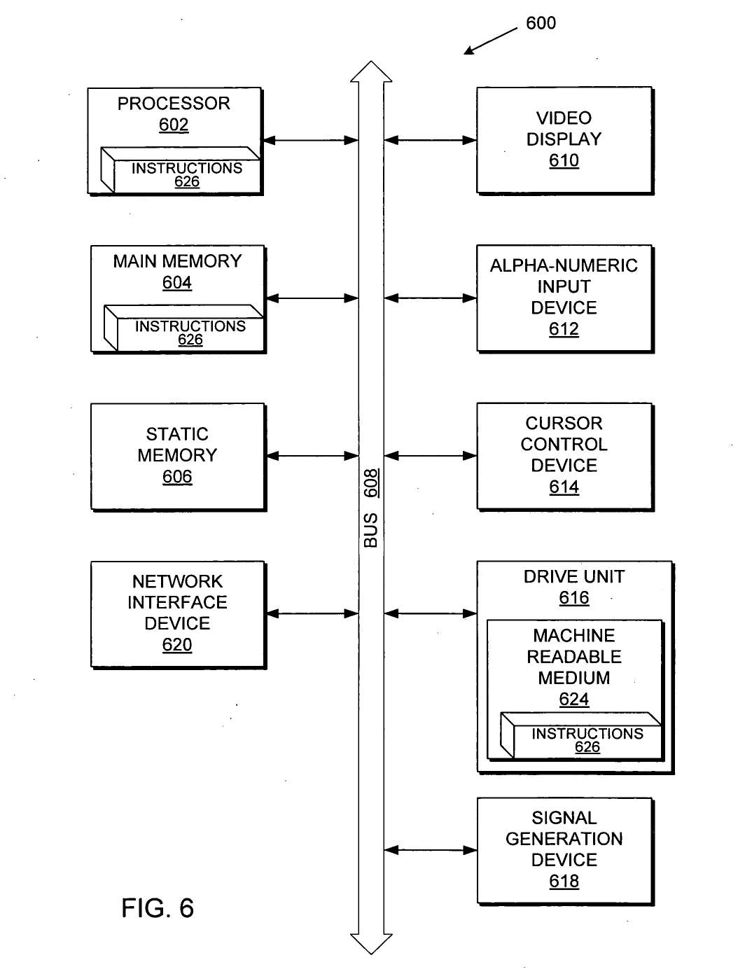

FIG. 6 shows a diagrammatic representation of a machine in the exemplary form of a computer system 600 within which a set of instructions, for causing the machine to perform any one of the methodologies discussed above, may be executed. In one embodiment, the computer system 600 may incorporate a master processing machine 210 or a slave processing machine 230. Alternatively, the master processing machine 210 and/or the slave processing machine 230 may include fewer devices and modules, or an additional number of devices and modules, than the system 600 shown in FIG. 6.

The computer system 600 includes a processor 602, a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alphanumeric input device 612 (e.g., a keyboard), a cursor control device 614 (e.g., a mouse), a disk drive unit 616, a signal generation device 618 (e.g., a speaker), and a network interface device 620.

The disk drive unit 616 includes a machine-readable medium 624 on which is stored a set of instructions (i.e., software) 626 embodying any one, or all, of the methodologies described above. The software 626 is also shown to reside, completely or at least partially, within the main memory 604 and/or within the processor 602. The software 626 may further be transmitted or received via the network interface device 620.

It is to be understood that embodiments of this invention may be used as or to support software programs executed upon some form of processing core (such as the CPU of a computer) or otherwise implemented or realized upon or within a machine or computer readable medium. A machine readable medium includes any mechanism for storing or transmitting information in a form readable by a machine (e.g., a computer). For example, a machine readable medium includes read-only memory (ROM); random access memory (RAM); magnetic disk storage media; optical storage media; flash memory devices; electrical, optical, acoustical or other form of propagated signals (e.g., carrier waves, infrared signals, digital signals, etc.); or any other type of media suitable for storing or transmitting information.

In the foregoing specification, the invention has been described with reference to specific exemplary embodiments thereof. It will, however, be evident that various modifications and changes may be made thereto without departing from the broader spirit and scope of the invention as set forth in the appended claims. The specification and drawings are, accordingly, to be regarded in an illustrative sense rather than a restrictive sense.

What is claimed is:

1. A method comprising:
initiating processing of a plurality of task files stored within a storage device, said plurality of task files being organized in descending order based on a respective processing time parameter associated with each task file; and
processing successively an available task file from said plurality of ordered task files.

2. The method according to claim 1, wherein said processing time parameter characterizes the length of time necessary for said processing of said each task file.

3. The method according to claim 1, further comprising:
retrieving said plurality of task files from said storage device;
ordering said plurality of task files in descending order based on said processing time parameter associated with said each task file to obtain ordered task files; and
storing said ordered task files within said storage device.

4. The method according to claim 1, wherein said initiating further comprises:
transmitting a command to start processing of task files to at least one slave processing machine coupled to said storage device.

5. The method according to claim 3, wherein said processing further comprises:
requesting a task file from said storage device;
retrieving said available task file from said ordered task files; and
processing said available task file prior to a further request for another task file.

6. The method according to claim 3, wherein said processing further comprises:
successively requesting a task file from said storage device until said available task file is accessible from said ordered task files;
retrieving said available task file; and
processing said available task file prior to a further request for another task file.

7. A system comprising:
a storage device to store a plurality of task files being organized in descending order based on a respective processing time parameter associated with each task file; and
a plurality of processing machines coupled to said storage device, each processing machine to process successively an available task file from said plurality of ordered task files.

8. The system according to claim 7, wherein said processing time parameter characterizes the length of time necessary for said processing of said each task file.

9. The system according to claim 7, wherein a master processing machine of said plurality of processing machines further retrieves said plurality of task files from said storage device, orders said plurality of task files in descending order based on said processing time parameter associated with said each task file to obtain ordered task files, and stores said ordered task files within said storage device.

10. The system according to claim 7, wherein a master processing machine of said plurality of processing machines further transmits a command to start processing of task files to at least one slave processing machine of said plurality of processing machines coupled to said storage device.

11. The system according to claim 9, wherein each processing machine of said plurality of processing machines further requests a task file from said storage device, retrieves said available task file from said ordered task files, and processes said available task file prior to a further request for another task file.

12. The system according to claim 9, wherein each processing machine of said plurality of processing machines further requests successively a task file from said storage device until said available task file is accessible from said ordered task files, retrieves said available task file, and processes said available task file prior to a further request for another task file.

13. A computer readable medium containing executable instructions, which, when executed in a processing system, cause said processing system to perform a method comprising:
initiating processing of a plurality of task files stored within a storage device, said plurality of task files being organized in descending order based on a respective processing time parameter associated with each task file; and
processing successively an available task file from said plurality of ordered task files.

14. The computer readable medium according to claim 13, wherein said processing time parameter characterizes the length of time necessary for said processing of said each task file.

15. The computer readable medium according to claim 13, wherein said method further comprises:
retrieving said plurality of task files from said storage device;
ordering said plurality of task files in descending order based on said processing time parameter associated with said each task file to obtain ordered task files; and
storing said ordered task files within said storage device.

16. The computer readable medium according to claim 13, wherein said initiating further comprises:
transmitting a command to start processing of task files to at least one slave processing machine coupled to said storage device.

17. The computer readable medium according to claim 15, wherein said processing further comprises:
requesting a task file from said storage device;
retrieving said available task file from said ordered task files; and
processing said available task file prior to a further request for another task file.

18. The computer readable medium according to claim 15, wherein said processing further comprises:
successively requesting a task file from said storage device until said available task file is accessible from said ordered task files;
retrieving said available task file; and
processing said available task file prior to a further request for another task file.

19. A system comprising:
means for initiating processing of a plurality of task files stored within a storage device, said plurality of task files being organized in descending order based on a respective processing time parameter associated with each task file; and
means for processing successively an available task file from said plurality of ordered task files.

20. The system according to claim 19, wherein said processing time parameter characterizes the length of time necessary for said processing of said each task file.
